(19) United States
(12) Patent Application Publication
(10) Pub. No.: US 2011/0159855 A1
(43) Pub. Date: Jun. 30, 2011

(54) METHOD FOR PROVIDING BACKGROUND SOUND TO COMMUNICATION DEVICE AND SYSTEM APPLYING THE METHOD

(75) Inventor: Chi-Chen Cheng, Taipei (TW)

(73) Assignee: C-MEDIA ELECTRONICS INC., Taipei (TW)

(21) Appl. No.: 12/876,140

(22) Filed: Sep. 5, 2010

(30) Foreign Application Priority Data
Dec. 31, 2009 (TW) 098146210

(51) Int. Cl. H04M 3/42; H04M 15/06

(52) U.S. Cl. 455/414.1; 379/207.02; 379/142.04

(57) ABSTRACT

Disclosed is a method for providing background sound to a communication device and a system applying the method. The method is preferably applied to a voice communication procedure. In the meantime, a background sound is simultaneously played with a telephone call according to a user's selection or a sound schedule. In accordance with an embodiment, the steps in the method firstly include a step of receiving a call, and a step of activating a noise-suppression function and a background-sound enabling procedure. The background-sound enabling procedure is conducted to play the background sound at the time of the call based on the user's selection, or a sound schedule. In particular, the user can decide to play or not to play the background sound while phoning in the beginning. At last, the method ends the voice communication procedure with or without the background sound after hanging up the phone.

### BACKGROUND OF THE INVENTION

1. Field of the Invention

The present invention generally relates to a method for providing background sound to a communication device, and a system for the same, more particularly, a background sound is played with corresponding a schedule stored in a communication device as conducting a call procedure.

2. Description of Related Art

As conducting a voice communication procedure, background noise or other sound may interfere the voice quality. Some conventional technologies have been developed to eliminate the background noise. Such as U.S. Pat. No. 5,748,725, issued on May 5, 1998, which disclosed a telephone set with background noise suppression function. The telephone set is provided with a microphone at the position next to a speaker. This microphone is used to output the signals with remaining noise. There is another one microphone used for outputting the background noise. A noise elimination circuit in the telephone set estimates the background noise reaching the ear based on the background noise signal, the signals with remaining noise, and the received voice signal. After subtracting the estimated background noise from the received voice, a more clear sound may be obtained.

The mentioned background noise suppression function may assist the telephone in inserting other sound effect during the voice communication procedure. The sound effect may be the sound of a particular situation. The related technology may be referred to R.O.C. Patent No. I257237, issued on Jun. 21, 2006, which disclosed a system for combining the background sound into the telephone call.

FIG. 1 shows a diagram of a mobile communication device with the background sound of a particular situation of the conventional art. A first mobile phone 11 adopts the system 100 for combining the telephone call and the background sound. Therefore, when a user uses the first mobile phone 11 to call the other user using the second mobile phone 12, the user may selectively uses the system 100 to combine a background sound with the call. The background sound can be one of the listed files, such as the background sound on a street (101), the background sound on a mass rapid transit train (102), the background sound in a rock'n roll music concert (103), the background sound in a food market (104), or the background sound in a meeting room (105), for example. That means the selected background sound can be heard simultaneously as calling.

The above-mentioned sound effect may be used for interfering or inserting a particular situation simulation into a normal call, and make the recipient believe the caller's current environment.

### SUMMARY OF THE INVENTION

In order to provide a background sound during the voice communication procedure for entering an effect, disclosed is a method for providing the background sound to a communication device and a system using the method. In particular, the system provides a scheme to simultaneously play selected or schedule-configured background sound as conducting the voice communication procedure. The scheme to play the background sound may be associated with a noise-suppression function which may make a better environment to play the sound.

In accordance with the embodiment, a method for providing the background sound to a communication device is disclosed. The method includes a step of simultaneously activating a noise-suppression function and initiating a background-sound enabling procedure as receiving an incoming call. The background-sound enabling procedure provides a user to make a choice of whether or not to play the background sound during the voice communication procedure. The user may also choose the sound from a menu. Alternatively, the background sound to be played may be in accordance with a predetermined background-sound schedule in order to play the sound according to the time configured in the schedule. The call procedure and the background sound are ended as hanging up the call.

More particularly, the background sound to be played may correspond to each incoming call. More, each incoming call may match one particular background-sound schedule and a corresponding background sound is selected in accordance with the caller ID.

A communication system applying the above-described method for providing the background sound to the communication device is further disclosed. The system preferably includes a server which stores a plurality of files of background sound. Through a communication network connected with the server, a communication device embodies the method. The device can be a mobile phone or a computer system to process the network communication. The device with communication capability includes one or more background-sound schedules stored in a memory. While the schedule is configured, the required background sounds may be downloaded from the server. As conducting the call procedure, a noise-suppression function can be activated. In accordance with the time of the call procedure, the corresponding background sound configured in the background-sound schedule is played.

In another embodiment, if it is determined that no background sound is in the memory as conducting the call procedure, the device may synchronously connect to a server for streaming the required background sound.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram showing a mobile communication device with environmental background sound in the conventional art;

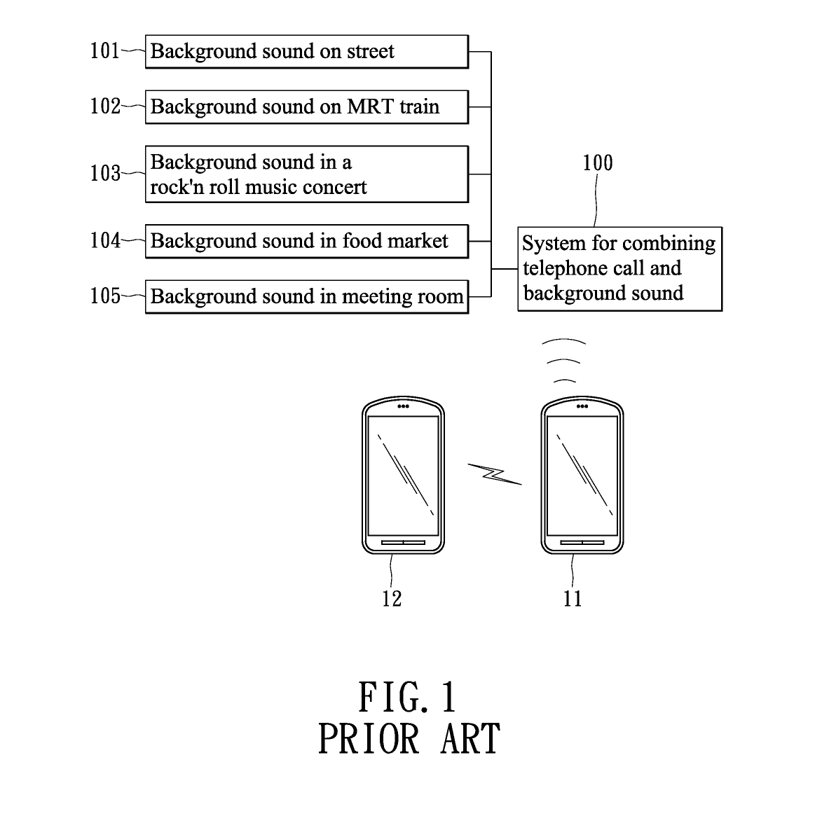

FIG. 2 shows a diagram illustrating a communication system applying the method for providing background sound to the device in accordance with the present invention;

FIG. 3A illustrates a flow chart of the method for providing background sound to the communication device in accordance with the present invention;

FIG. 3B is a flow chart of the method for answering the call using the communication device capable of playing the background sound;

FIG. 4A is one of the schematic diagrams illustrating a schedule employed in the communication device capable of playing the background sound;

FIG. 4B is the other one of the schematic diagrams illustrating a schedule employed in the communication device capable of playing the background sound;

FIG. 5 illustrates a flow chart of the first embodiment of the method for providing the background sound to the communication device in accordance with the present invention;

FIG. 6 illustrates a flow chart of the second embodiment of the method in accordance with the present invention;

FIG. 7 illustrates a flow chart of the third embodiment of the method in accordance with the present invention;

FIG. 8 illustrates a flow chart of the fourth embodiment of the method in accordance with the present invention.

### DETAILED DESCRIPTION OF THE PREFERRED EMBODIMENTS

While the present invention will be described more fully hereinafter with reference to the accompanying drawings, in which a preferred embodiment(s) of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The method for providing background sound to the communication device in accordance with the present invention is introduced in a voice communication procedure. The selected background sound or the sound configured in a schedule may be simultaneously played with the call. The method is especially applied to a mobile phone. More, a noise-suppression function may be incorporated into the voice communication procedure. The call may be processed with the background sound accompanied with the noise-suppression function. In another embodiment, the method may be applied to a personal computer, which is equipped with the communication peripherals, such as microphone and speaker, and network communication software. During the voice communication procedure, the background sound may also be inserted.

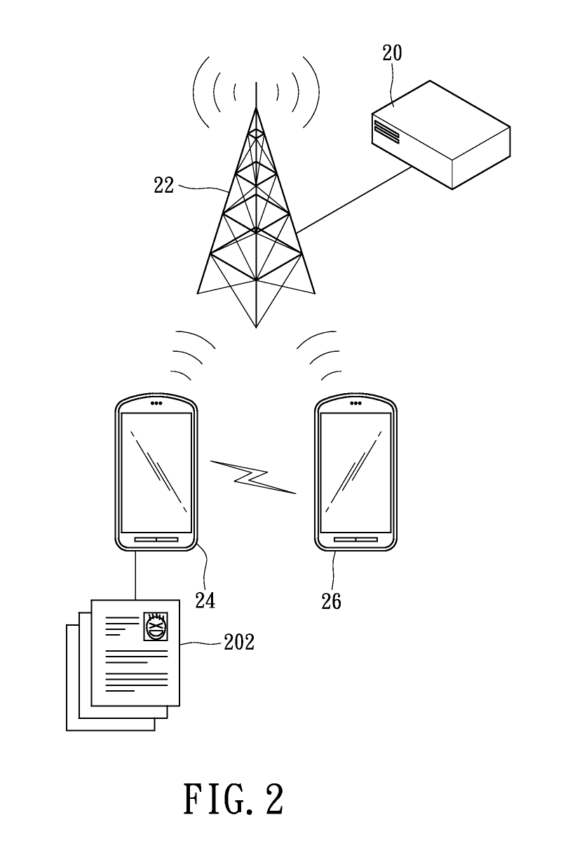

FIG. 2 shows a schematic diagram of a communication system introducing the method for providing background sound to the communication device in accordance with the present invention. The system may also include a server 20 which stores the plural files of the various background sounds. A user may utilize a first mobile communication device 24 or a second mobile communication device 26 to implement the communication over a network. Especially through a wireless base station 22, the mobile communication device may link to the server 20.

Reference is made to current case, the user utilizes the mobile communication device 24 to receive an incoming call from the second mobile communication device 26. Meanwhile, the user may use a user interface via the device 24 to execute the function of playing the background sound. The user interface prompts the user to decide or not to insert the background sound. The menu provides the user a list to make a selection such as the diagram shown in FIG. 2. The first mobile communication device 24 may have an incoming call lookup table 202. According to the table, the background corresponding to the caller ID carried with the incoming call is played. The background sound may also be configured to a predetermined background-sound schedule, and thereby the sound corresponding to different time may be played. The background-sound schedule may be one or more schedules in accordance with different incoming calls.

In addition to the above-described background-sound schedule corresponding to each incoming call, the network domain detected by the wireless network module built in the mobile communication device may be incorporated. For example, each wireless network domain should have its recognizable SSID. Any wireless network domain may simply be used to identify its location. Such as a SSID directed to a specific network domain, which may be inside a company, and be used for determining where it is located at. Similarly, other places, such as coffee shop, MRT station, rail station, hospital, airport and the like, may have their recognizable SSIDs which may be used to determine the location. Further, the background sound to be played may refer to the location, or further collocated with a specific background-sound schedule. The schedule rules the background sound to be played during the voice communication procedure.

Furthermore, the claimed system incorporates the GPS (global positioning system) in the mobile communication device to obtain an accurate positioning. The background sound may be associated with the position. Further a relevant background-sound schedule may also be incorporated. Therefore, the corresponding background sound may be played in accordance with the schedule in the voice communication procedure.

The claimed communication system may download the background sound(s) being selected from a server 20 over the communication. Or alternatively, the required background sound may be streaming downloaded from the server in the voice communication procedure. A payment system may be introduced for users paying for the downloaded background sound.

In particular, the communication device may use a payment mechanism to download a digital content, especially from a remote server. In practice, the communication device may pre-install a portion of the background sound. If the user needs to the full version of the sound, he may pay for downloading the full version of sound according to a regulation made by the provider.

Followings are the major payment modes:

Lease mode is provided for users streaming the requested background sounds in a lease term. The streaming downloaded background sounds may not stored in the communication device.

One further payment mode is for users paying for the files of background sound provided by some suppliers and downloading the files into the memory of communication device by preference.

In another payment mode in an embodiment, some background sounds may be preloaded in the communication device. The preloaded digital content may be a full version file or a preview version (partial version) file. After testing the preloaded portion of the background sound, the users may consider whether or not paying for the full version. In a preferred embodiment, the user may temporarily and instantly use the background sound since he confirms the payment. After reconfirming the payment or receiving the related register signal in a certain period, the user actually owns the complete privilege and without time limit of the file. The mentioned register signal may be delivered via short message service. The user may fully use the file after receiving the register code.

The payment may be charged by a regular bill for mobile communication, or by any stored value. More particularly, the user may not only use the mobile phone, but also any device for network voice communication, such as a computer system with a VoIP program and a set of communication peripherals, a handheld device, or the like. A noise-suppression function is particularly introduced into the device capable of networking in order to provide the background sound as conducting the call procedure. The noise-suppression function is to suppress the ambient background noise through a signal processing.

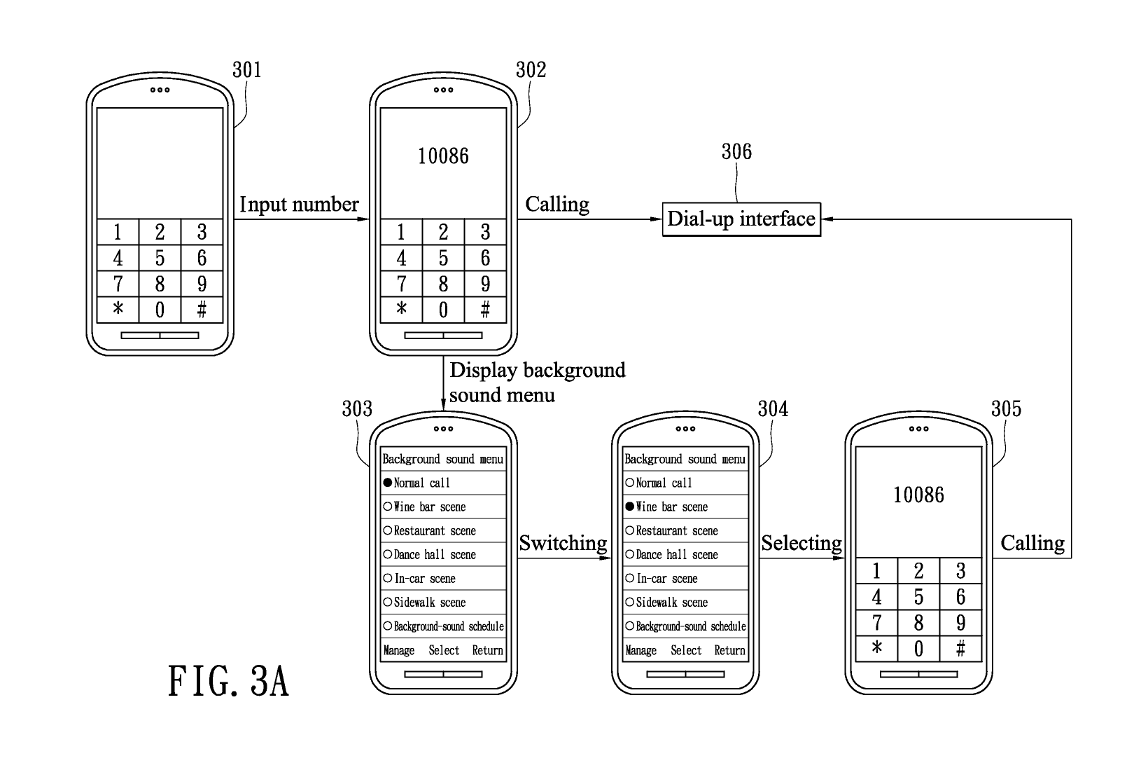

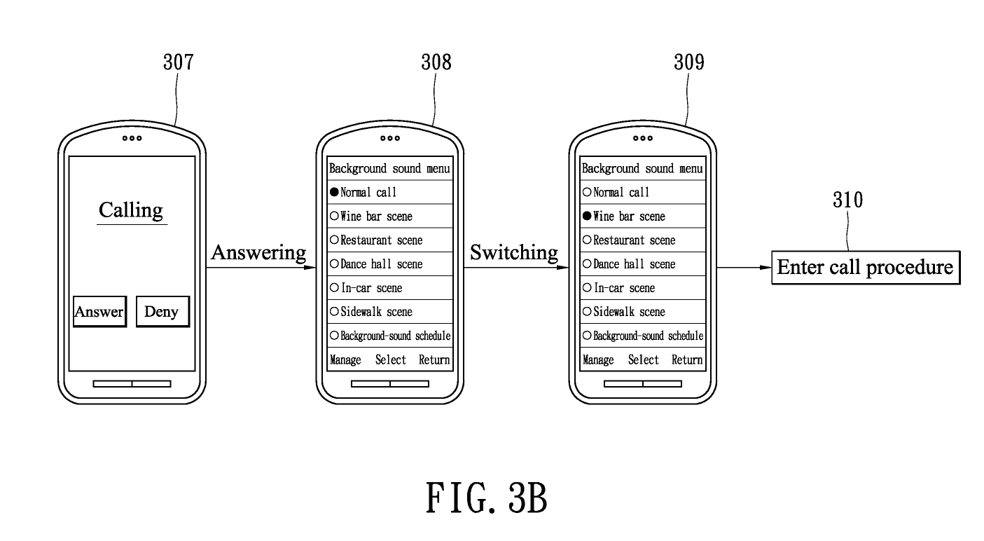

The method for providing the background sound to the communication device in accordance with the present invention may be applicable to both dialing up and answering sides. FIG. 3A and FIG. 3B show the flow charts illustrating the call process with the background sound scheme in accordance with the present invention.

FIG. 3A is a call process of dialing up. The figure shows a sequence of snapshots of a dialing process with time. An interface with one-touch control is particularly introduced. The one-touch control simplifies the manual operations. For example, the snapshot 301 shows a user using a numeral keypad to dial up a number. The next snapshot 302 shows the number is “10086”. After pushing the dial button, the snapshot 303 with a background-sound menu may be automatically shown up. This example shows an item of normal phoning without the background sound, and some other items, including a wine bar scene, a restaurant scene, a dance hall scene, a scene inside a car, a sidewalk scene, and an item of a background-sound schedule.

Meanwhile, such as the snapshot 304, the user selects the item of normal phoning or switches to a wine bar scene. Next, the process enters the snapshot 305 that displays a number. Then the process dials up (306). More particularly, the noise-suppression function may be activated while playing the selected sound. Then the background sound may be played more clearly for reaching a preset purpose.

The above-described items include an item of the background-sound schedule which provides a specific background sound being played with time in accordance with the user's configuration. In another embodiment, the call process may ignore the items to be selected but directly perform the background sound in accordance with the background-sound schedule. The menu may also list an item of the noise-suppression function for the users to decide whether or not to activate the noise-suppression function.

FIG. 3B is a flow chart of answering a call using the method for providing background sound to the communication device in accordance with the present invention. A concise user interface is particularly introduced to the scheme of providing the background sound. While the user receives an incoming call, the concise user interface provides the user to select one of the items on the menu in a short time.

In accordance with the embodiment, the noise-suppression function is used to prepare a great environment for playing the background sound. However, it is not every call requiring activating the noise-suppression function. For example, the user may answer the call under quieter surroundings, or by turning on the loud speaker with handsfree. Alternatively, the user may also decide not to activate the noise-suppression function. Therefore, the invention provides the users to make a decision as to whether or not activate the noise-suppression function while answering the incoming call.

As the snapshot 301, which shows the device screen displaying both who is the incoming call, and a selection of answering or denying. If the user denies answering the call, he hangs up the call. If the user answers the call, the screen then displays the snapshot 308. The user may decide whether or not to activate the noise-suppression function according to his occasion, or an answering mode including turning on the loud speaker.

The snapshot 308 shows a menu having a plurality of items of background sounds, on which an item of background-sound schedule is also listed. The user may select one of the background sounds in the voice communication procedure. Or alternatively, one timed background sound configured in the background-sound schedule may be played. This selection may be ignored in another embodiment, and the timed background sound is directly played. After the user makes the selection, such as snapshot 309, it enters the call procedure (310).

According to one of the embodiments of the present invention, the incoming call may correspond to a special sound. Or alternatively, the incoming call may have its corresponding background-sound schedule. During the voice communication procedure, the corresponding background sound is played. Not only the background sound may be the situational sounds in some specific occasions, but also the music stored in the device or streaming from a remote storage.

In one embodiment, the call procedure may provide a function of activating or deactivating monitoring the background sound. In particular, a software-implemented or hardware switch is used to switch the function of monitoring the background sound. The timing of the switching may be at the time to dial up or before the answering the call. However, the user can switch the monitoring function during the voice communication procedure. For example, the user may not need to hear the background sound as making the call, and the monitoring function can be switched off. If the user desires to hear the background sound as well as the caller or recipient, the monitoring function can be switched on.

Furthermore, the background sound is adjustable, so that the call procedure may include a function of adjusting the volume. For example, a switch may be disposed on the device for adjusting the volume of sound, and especially the volume adjustment for the background sound is independent from the system volume. The switch can also be implemented by software. The aforementioned monitoring function may have its independent sound volume adjustment scheme.

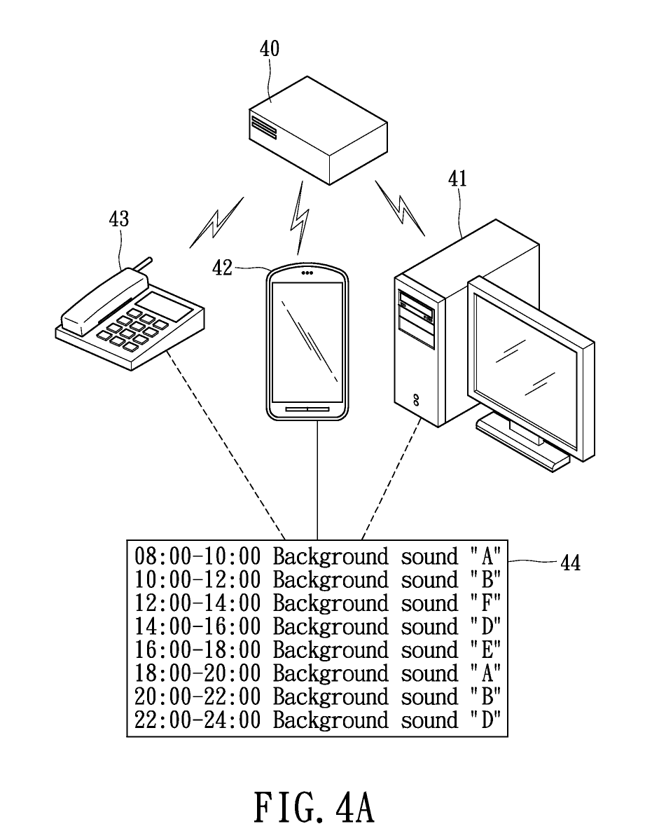

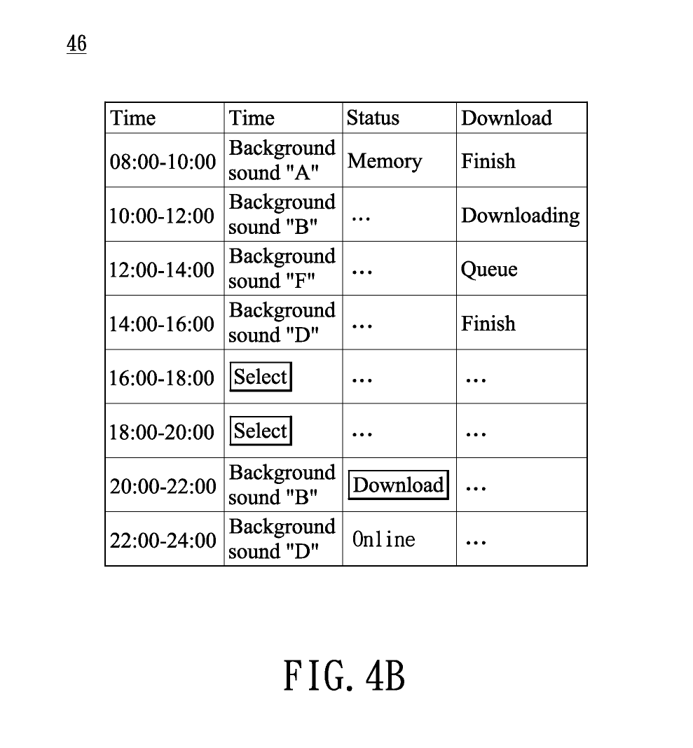

Reference is made to FIG. 4A illustrating the schematic diagram of the embodiment of the background-sound schedule which is applicable to the mobile communication device in accordance with the present invention.

The mobile communication device 42 may connect to a server 40 for downloading the background sound over a communication network. This mobile communication device 42 preferably includes a background-sound schedule 44. The content of the schedule may refer to the diagram. It is similar to the regular calendar which contains a time schedule with corresponding background sounds. The user may configure the schedule based on the different hours and the corresponding sounds.

For example, when the call procedure begins at 08:00 to 10:00, the background sound “A” is inputted. Further, when the call procedure begins at 10:00 to 12:00, the background sound “B” is inputted. Still further, when the call procedure begins at 12:00 to 14:00, the background sound “F” is inputted. Further, the background sound “D” is entered when the call procedure begins at 14:00 to 16:00. Further, the background sound “E” is entered when the call procedure begins at 16:00 to 18:00. Furthermore, the background sound “A” is also for the call procedure at 18:00 to 20:00. The background sound “B” is further for the time 20:00 to 22:00, and the background sound “D” is for the time 22:00 to 24:00.

The mobile communication device 42 further includes a plurality of background-sound schedules 44 with corresponding incoming calls.

The mentioned background-sound schedule 44 is also adapted to the other devices capable of networking, such as a personal computer system and other types of communication devices which perform VoIP. Particularly, a VoIP program is executed in the computer system, in which the program carries the background-sound schedule 44. The VoIP program provides many user interfaces for further configurations. Furthermore, the background-sound schedule 44 includes a schedule corresponding to one or more incoming calls.

In accordance with one more embodiment, the method for providing background sound is also applicable to the home phone 43, especially to the phone with network communication function (i.e. the VoIP phone). This type of phone has a memory which stores files of background sound and a background-sound schedule 44. Similar to the mentioned voice communication procedure with the background sound, the home phone may provide different background sound schedule corresponding to the different incoming calls.

Reference is made to FIG. 4B, which shows a time table installed in the communication device. The table indicative of a background-sound schedule 46 records the time schedule and the corresponding background sounds. The different times correspond to different background sounds. The table further shows the status for each file of background sound, including the file as in the memory, as downloading, as queue for waiting for download, or as online.

An exemplary example is shown in FIG. 4B. For example, the background sound “A” is set at 08:00 to 10:00, and the related file is completely downloaded and stored in a memory of a device. Further, the status of the background sound “B” at 10:00 to 12:00 is “downloading”. Further, the selected background sound “F” at 12:00 to 14:00 is queued for waiting for download.

Other background sounds set at 16:00 to 18:00 and 18:00 to 20:00 may be selected from the records in the memory, or required to be downloaded from a remote server. The background sound “B” set at 20:00 to 22:00 is the one required for download command. The status of background sound “D” set at 22:00 to 24:00 is “online”, that means the related file is streaming downloaded from the server as receiving the play command.

The device with communication capability further includes a plurality of background-sound schedules 46, which may be individually configured to the different incoming calls.

According to the method for providing the background sound to the communication device in accordance with the present invention, it is featured that a noise-suppression function and a background-sound enabling procedure are simultaneously activated as receiving the incoming call. The background-sound enabling procedure provides the user to make a decision of whether or not to play the background sound in the voice communication procedure. Or the user may select one of the files of background sound to be played. Alternatively, the procedure may follow the pre-determination of the background-sound schedule. Furthermore, the procedure may provide the background sound corresponding to each incoming call, or provide the schedule for each incoming call.

In one more embodiment, the background-sound enabling procedure may synchronously establish a connection with the server for streaming a selected background sound if it is not existed in the local memory. The scheme to establish the connection may adopt the various communication means, such as the wireless network—including 3G/3.5G/GPRS/WiFi, or the wired network. Therefore, when the procedure initiates a process of playing the sound as conducting the call procedure, the required background sound is synchronously downloaded by streaming.

### First Embodiment

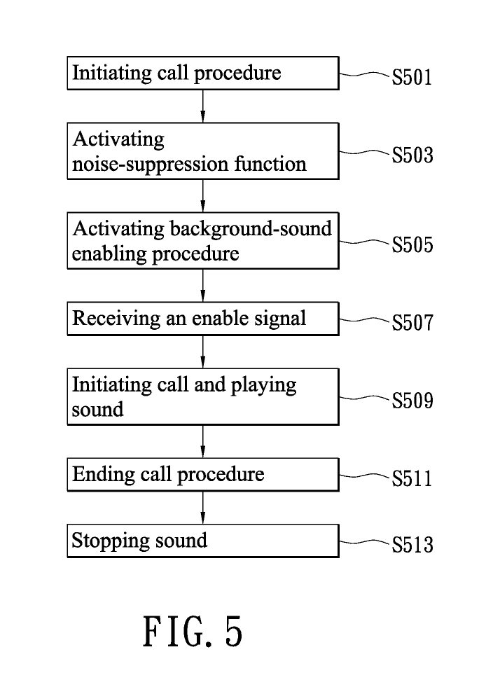

Reference is made to FIG. 5 showing a flow chart of the method for providing the background sound to the communication device.

Step S501 initiates a call procedure. While the user answers the call, a noise-suppression function is activated (step S503). Next, a background-sound enabling procedure is also activated (step S505). This procedure includes a step of displaying several snapshots with a plurality of items. The snapshots may be referred to FIG. 3, including the snapshot of enquiring whether or not to answer the call, to activate the noise-suppression function, to play the background sound, and to provide the background sound menu. After the user agrees to play the background sound, the system may receive an enable signal (step S507). The enable signal is a select signal based on the background sound menu. The enable signal is also directed to a selected background sound. The step in the method is then to initiate the call and play the selected sound (step S509). While the user hangs up the call, the call procedure ends (step S511). At the same time, the background sound stops (step S513).

### Second Embodiment

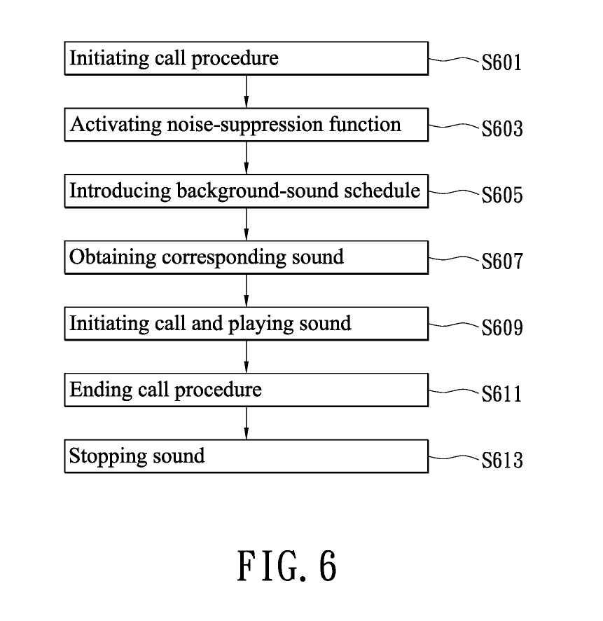

FIG. 6 shows a flow chart of illustrating the method for providing the background sound to the communication device of the embodiment in accordance with the present invention.

A call procedure is initiated as receiving an incoming call in step S601. At this moment, the device with communication capability synchronously activates the noise-suppression function in step S603. The noise-suppression scheme is used for providing a better environment to play the background sound. However, the noise-suppression function is not always needed in some embodiments. For example, the call procedure is initiated at a quiet place, or some devices may not provide this function.

After that, a background-sound schedule is introduced (S605). The background-sound schedule records a time table having the time periods and their corresponding sounds, including music. The user may also set a specific time period not corresponding to any sound. In an exemplary example, the background-sound enabling procedure may provide the specific background sound according to the position of the device. As such, the device may be equipped with a wireless network module which is used for detecting the network domain where it locates. Then the background-sound schedule may be configured to set any background sound according to the detected domain. Moreover, a GPS (global positioning system) module may be associated with the background-sound schedule according to one more embodiment. Referring to the position detected by the global positioning system module disposed in the device, a corresponding background sound is played.

The step in the method then obtains the sound with corresponding the incoming call or the device's position (step S607). In the example, the background-sound enabling procedure checks the time set in the background-sound schedule in advance. Then the enable signal is directed to a corresponding background sound. After answering the call, such as step S609, the background sound is initiated. After handing up the call (step S611), the background sound stops (step S613).

### Third Embodiment

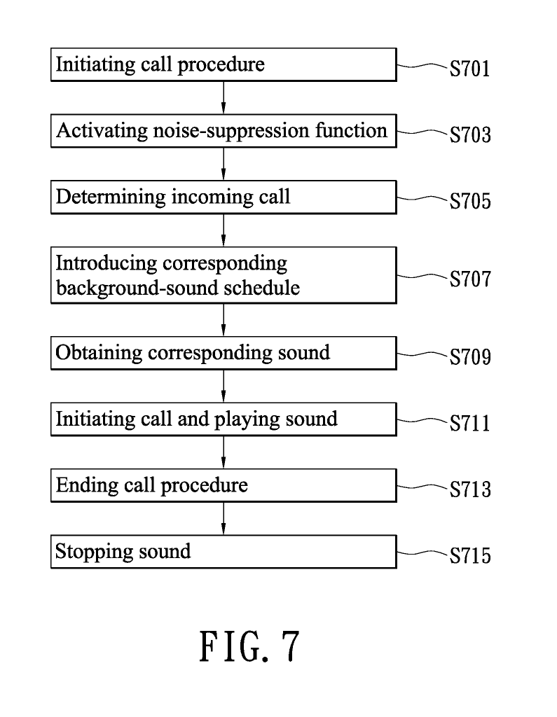

In general, the incoming call may carry a caller ID. Therefore, the background-sound enabling procedure may obtain the background sound in accordance with the caller ID. The relevant process may be referred to FIG. 7, which illustrates the steps of the method in accordance with the present invention.

In step S701, it initiates a call procedure. Then the noise-suppression function is also activated in step S703. Next, the step S705 in the method is to determine who corresponds to the incoming call. Preferably, the method determines the incoming call by referring to the caller ID. The caller ID then introduces a corresponding background-sound schedule (step S707). Therefore, the background-sound enabling procedure may provide the corresponding background sound according to the caller ID. It is featured that the every incoming call may have its special situation since the enable signal is directed to the corresponding background sound in reference with the background-sound schedule (step S709). After that, the corresponding background sound is played as conducting the call procedure (step S711). After hanging up the call (step S713), the background sound stops (step S715).

### Fourth Embodiment

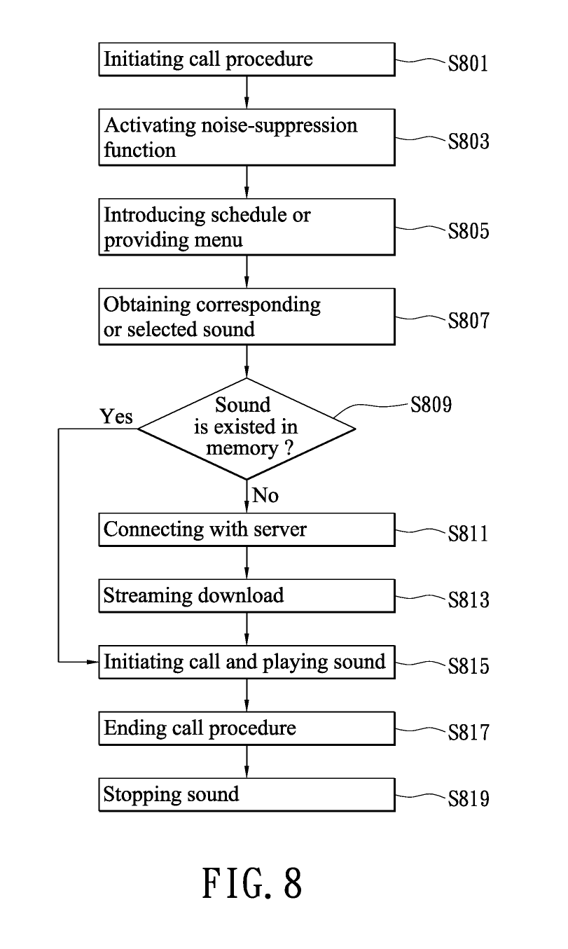

FIG. 8 shows a flow chart of the fourth embodiment of the method in accordance with present invention. Not only the background sounds stored in the memory can be used for the call procedure, but also the file synchronously downloaded from a remote server may be used for providing the background sound scheme. Those ways are selectively provided.

According to the embodiment, such as step S801, it initiates a call procedure. Meanwhile, a noise-suppression function is activated (step S803). Then the background-sound enabling procedure introduces a background-sound schedule or provides a menu (step S805). A schedule-configured background sound may be obtained, or a user may accordingly select one of them by the menu (step S807). In one embodiment, with an incoming call, a corresponding background-sound schedule or a menu may be provided accordingly. In particular, an enable signal can be used for determine whether or not playing the background sound, that is to initiate a call procedure without background sound, or another call procedure with background sound.

In an exemplary example, the following step is to enable a background-sound enabling procedure. This procedure may determine whether the selected sound is stored in the memory or not (step S809). If the sound in accordance with the schedule or the selected sound has been always recorded into the memory of the device, the method performs step S815. The step S815 in the method is to initiate the call procedure and synchronously play the sound. If the sound recorded in the schedule or the selected sound is not existed in the memory, the step is to connect with the remote server as conducting the call procedure (step S811). Then the related background sound is streaming downloaded (step S813). Then, such as step S815, the step is to initiate the call and simultaneously play the sound. After hanging up the call (step S817), the sound stops (step S819).

In the summation of the above description, the method for providing the background sound to a communication device, and a communication system applying the method in accordance with the present invention primarily introduces a background-sound schedule into the call procedure. The background-sound schedule records the time periods and the corresponding background sounds. It provides the various situational sound effects. More particularly, based on the background-sound schedule, the method provides the different schedules individually for the plural incoming calls.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method for providing background sound to a communication device, comprising:
initiating a call procedure;
activating a background-sound enabling procedure, and introducing a background-sound schedule;
receiving an enable signal, wherein while the enable signal is used to determine not playing a background sound, initiating the call procedure without background sound; or while the enable signal is used to determine playing the background sound, initiating the call procedure with background sound in accordance with the background-sound schedule; and
ending the call procedure with or without the background sound after hanging up the call.

2. The method of claim 1, further comprising a step of activating a noise-suppression function after initiating the call procedure.

3. The method of claim 1, wherein the call procedure includes a step of activating or deactivating monitoring the background sound.

4. The method of claim 1, wherein the call procedure has an incoming call which records a caller ID, and the background-sound enabling procedure enables one of the background sounds according to the caller ID.

5. The method of claim 4, wherein the method provides a plurality of background-sound schedules, and the caller ID corresponds to one of the background-sound schedules.

6. The method of claim 1, wherein the background-sound enabling procedure includes displaying a background sound menu for the background sound selected by a user.

7. The method of claim 6, wherein the background-sound schedule is included in the background sound menu which is provided for deciding whether or not playing the background sound configured in the background-sound schedule.

8. The method of claim 6, wherein the background sound menu includes a noise-suppression function which is provided for deciding whether or not activating the noise-suppression function in the call procedure.

9. The method of claim 1, wherein the background-sound enabling procedure is to play the background sound with corresponding background-sound schedule in accordance with a network domain detected by a wireless network module in a communication device.

10. The method of claim 1, wherein the background-sound enabling procedure is to play the background sound with corresponding background-sound schedule in accordance with a position determined by a global positioning system module in a communication device.

11. The method of claim 1, wherein volume of the background sound is adjustable as conducting the call procedure.

12. A method for providing a background sound to a communication device, comprising:
initiating a call procedure;
activating a background-sound enabling procedure, and introducing a background-sound schedule;
receiving an enable signal;
initiating the call procedure without background sound if it is determined that no background sound is played according to the enable signal;
initiating the call procedure with background sound if it is determined that the background sound is played according to the enable signal; and determining whether or not the background sound corresponding to a time in comparison with the background-sound schedule is stored in a memory;
playing the background sound as initiating the call procedure if the background sound is stored in the memory;
synchronously streaming the background sound as linking a server in the initiated call if the background sound is not stored in the memory; and
ending the call procedure with or without the background sound after hanging up.

13. The method of claim 12, wherein the method activates a noise-suppression function after initiating the call procedure.

14. The method of claim 12, wherein the call procedure includes a step of activating or deactivating monitoring the background sound.

15. The method of claim 12, wherein the call procedure is initiated by an incoming call which carries a caller ID, and the background sound corresponding to the caller ID is selected in the background-sound enabling procedure.

16. The method of claim 15, wherein the method provides the plurality of background-sound schedules, and the caller ID corresponds to one of the background-sound schedules.

17. The method of claim 12, wherein the background-sound enabling procedure displays a background sound menu, and the enable signal directs to the selected background sound which is played as conducting the call procedure.

18. The method of claim 17, wherein the background-sound schedule is on a list in the background sound menu, it is determined whether or not to play the background sound, which is configured in the background-sound schedule, as conducting the call procedure.

19. The method of claim 17, wherein the background sound menu includes a noise-suppression function which is selectively activated as conducting the call procedure.

20. The method of claim 12, wherein the background-sound enabling procedure plays the background sound with corresponding background-sound schedule in accordance with a network domain detected by a wireless network module in a communication device.

21. The method of claim 12, wherein the background-sound enabling procedure plays the background sound with corresponding background-sound schedule in accordance with a position detected by a global positioning system module in a communication device.

22. The method of claim 12, wherein volume of the background sound is adjustable.

23. A communication system applying the method for providing background sound to a communication device of claim 1, wherein the system comprises:
a server storing a plurality of files of background sound; and
a device capable of communication wired or wirelessly with the server, and the device having a background-sound schedule for providing a background sound menu, a required background sound is downloaded from the server according to the background-sound schedule;
wherein, the device activates a noise-suppression function as conducting a call procedure, and the background sound is played at time of the call procedure in accordance with the background-sound schedule.

24. The system of claim 23, wherein the device is a mobile phone.

25. The system of claim 24, wherein the mobile phone is equipped with a wireless network module.

26. The system of claim 24, wherein the mobile phone is equipped with a global positioning system module.

27. The system of claim 23, wherein the device is a combination of a communication peripheral and a VoIP program installed in a personal computer.

28. The system of claim 23, wherein the background-sound schedule includes a schedule corresponding to one or more incoming calls.

29. The system of claim 23, wherein the background sound is streaming downloaded from the server and played in accordance with the background-sound schedule as conducting the call procedure.

30. The system of claim 23, wherein the required background sound is downloaded from the server on the time to configure the background-sound schedule.
